(19) United States
(12) Patent Application Publication
(10) Pub. No.: US 2002/0140181 A1
(43) Pub. Date: Oct. 3, 2002

(54) Reusable gasket

(76) Inventor: Michael Werner, Hohenkirchen-Siegertsbrunn (DE)

Correspondence Address: W. L. Gore & Associates, Inc., 551 Paper Mill Road, P.O. Box 9206, Newark, DE, 19714-9206, US

(21) Appl. No.: 09/820,214

(22) Filed: Mar. 28, 2001

(51) Int. Cl. F16J 15/46

(52) U.S. Cl. 277/628

(57) ABSTRACT

A manway gasket having a knitted wire mesh annular core; a composite FEP and ePTFE jacket disposed around and enclosing the core; wherein the jacket has a flex life of greater than 4,000,000 cycles; and wherein the jacket has a cut-through resistance of greater than 1000 Joules. The gasket also has an improved resiliency of greater than 5 percent and a leak rate of less than 0.01 mg/m/s.

### FIELD OF THE INVENTION

The present invention relates to gaskets and, more particularly, to a reusable gasket for repeatedly sealing a frequently opened port such as a manway.

### BACKGROUND OF THE INVENTION

Many types of gaskets exist for sealing joints or openings where the ingress or egress of fluids or other materials is to be prevented or limited. There are many applications for gaskets. One such application is for sealing around a port having a lid covering it that is frequently opened. A manway is an example of such frequently opened port. A manway is an opening or port providing access to an otherwise isolated environment, such as a reaction vessel. Many reaction vessels must be cleaned or serviced frequently. This requires the manway to be opened at least once a day in some circumstances. Each time the manway lid is closed, the gasket sealing the manway must effectively seal the opening. Particularly with glass-lined steel manways, where the steel of the lid or of some part of the vessel is lined with glass, it is often difficult to reestablish the seal because only minimal compressive forces can be exerted or else the glass will break. In such applications, a gasket is needed that is chemically resistant, has a low leak rate, is compressible and resilient, and is structurally sound enough to have a long life and repeatably seal the opening.

Current gaskets used for sealing glass-lined steel manways are envelope gaskets. An exemplary envelope gasket 90 is shown in FIG. 11. Envelope gasket 90 has a central annular core 91 of corrugated stainless steel. Sandwiching annular core 91 are two inserts 92 typically made of sheet materials like graphite or aramid fibers. Surface 92a is the upper surface of insert 92. Envelope 93, typically made of polytetrafluoroethylene (PTFE), is disposed on the inner surface 94 of envelope gasket 90 and folds over both inserts 92. In this manner, envelope 93 covers the inner inside surface 94 of envelope gasket 90, which is the surface that will be exposed to the fluid within the vessel. Envelope 93 also covers the top and bottom of envelope gasket 90. Envelope 93 does not completely enclose envelope gasket 90, however. Outside surface 95 of envelope gasket 90 does not have envelope 93 disposed over it.

There are several disadvantages to the use of envelope gaskets. The envelope gaskets are not structurally sound. In the event that a lid covering a manway and sealed by an envelope gasket is opened while there is still a vacuum in the vessel, the envelope (envelope 93 of FIG. 11) may be sucked into the vessel. This disrupts operation, requiring repair or replacement of the gasket. In addition, the envelope (envelope 93 of FIG. 11) of envelope gaskets is not typically durable enough to survive multiple openings and closings of the manway without being damaged. Such damage can lead to leaking. Finally, because the core (core 91 in FIG. 11) of the envelope gaskets is corrugated metal, it is not as compressible or as resilient as would be desired. The more resilient and compressible a gasket is, the more likely it is to produce a tighter seal by allowing the surfaces of the gasket to more intimately conform to the microstructure of the surface of the vessel and the lid. Absent such resilience and compressibility, leak paths may develop around the gasket. As a result of these disadvantages, envelope gaskets do not have a very long life and must be frequently replaced.

For frequently opened ports such as glass-lined manways in reaction vessels, what is needed is a gasket that is structurally sound enough not to be destroyed or damaged by the opening and closing of the manway, and is sufficiently compressible and resilient to repeatably seal the opening, thereby having a longer life in the field.

### SUMMARY OF THE INVENTION

The present invention provides a gasket having a knitted wire mesh annular core; a jacket comprising expanded polytetrafluoroethylene (ePTFE) disposed around and enclosing the core; wherein the jacket has a flex life of greater than 4,000,000 cycles; and wherein the ePTFE has a cut-through resistance of greater than 1000 Joules. The recovery of the inventive gasket is preferably greater than 5%, greater than 6%, greater than 7%, greater than 8%, and about 9%, respectively. Also preferably, the flex life of the jacket is greater than 5,000,000 cycles, greater than 6,000,000 cycles, greater than 7,000,000 cycles, and greater than 8,000,000 cycles, respectively. The cut-through resistance of the jacket is preferably greater than 2000 Joules, and most preferably greater than 3000 Joules.

In an alternative embodiment, the jacket includes at least one layer of ePTFE and at least one substantially impermeable barrier layer. In another embodiment, the jacket has an outer circumference and the gasket further comprises a retaining ring disposed around and contacting the outer circumference of the jacket. A plurality of pins are disposed on the retaining ring, the pins engaging the outer circumference of the jacket. A plurality of tabs extend from the outer circumference of the retaining ring.

In another embodiment, the gasket jacket has an outer circumference and an inner circumference, and the gasket further comprises a first retaining ring disposed around and contacting the outer circumference of the jacket and a second retaining ring disposed inside and contacting the inner circumference of the jacket. The inventive gasket also comprises combination of some or all of any of the features mentioned above.

In another aspect, the invention provides a method of sealing a manway having a base with an opening in it and a lid for covering the opening, the lid having an open position and a closed position, the method comprising the steps of: (1) providing a gasket comprising: a knitted wire mesh annular core; a jacket disposed around and enclosing the core, the jacket comprising a plurality of layers of ePTFE and a plurality of layers of FEP; wherein the jacket has a flex life of greater than 4,000,000 cycles; and wherein the jacket has a cut-through resistance of greater than 1000 Joules; and (2) disposing the gasket between the lid in the closed position and the base.

### BRIEF DESCRIPTION OF THE DRAWINGS

FIG. 1 is a top view of a gasket according to an exemplary embodiment of the invention.

FIG. 2 is a cross-sectional view of the gasket of FIG. 1.

FIG. 2A is a schematic diagram of a test set-up used for measuring a property of the present invention.

FIG. 3 is a side view of a device used to manufacture a gasket according to an exemplary embodiment of the invention.

FIG. 4 is a top view of a gasket according to another exemplary embodiment of the invention.

FIG. 4A is a top view of a gasket according to another exemplary embodiment of the invention.

FIG. 5 is a side view of a device used to manufacture a gasket according to an exemplary embodiment of the invention.

FIG. 6 is a side view of a device used to manufacture a gasket according to an exemplary embodiment of the invention.

FIG. 7 is a side view of a device used to test cut-through resistance of a gasket. FIG. 8 is a side view of a device used to test cut-through resistance of a gasket.

FIG. 8A is a graph of force vs. distance for a cut-through resistance test of a prior art gasket.

FIG. 8B is a graph of force vs. distance for a cut-through resistance test of a gasket according to an exemplary embodiment of the invention.

FIG. 9A is a graph of stress vs. time for a resilience test of a prior art gasket.

FIG. 9B is a graph of stress vs. time for a resilience test of a gasket according to an exemplary embodiment of the invention.

FIG. 10 is a cross-sectional view of a glass-lined steel manway including a gasket according to an exemplary embodiment of the invention.

FIG. 11 is a perspective view of a prior art gasket.

### DETAILED DESCRIPTION OF THE INVENTION

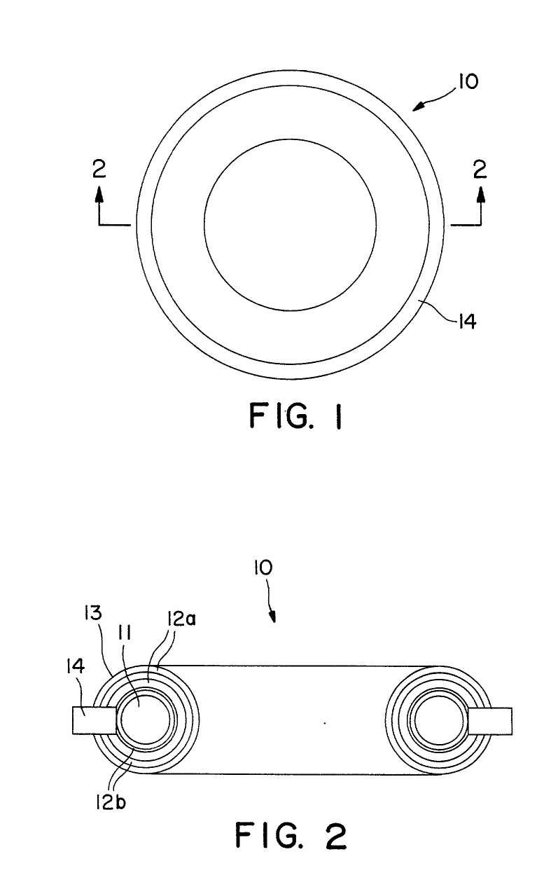

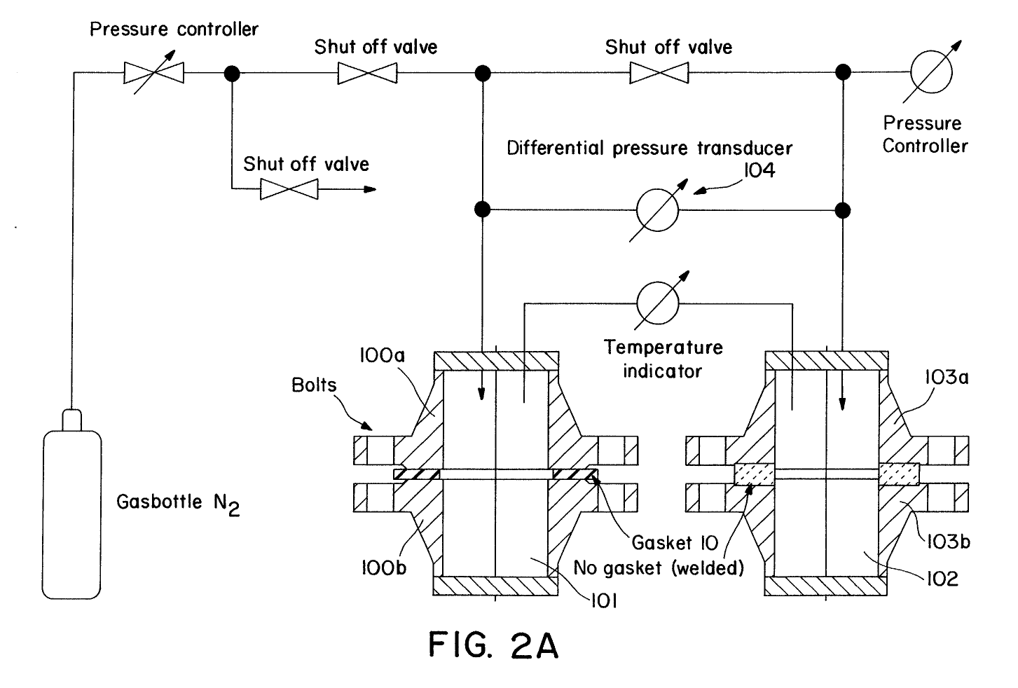

The inventive gasket will now be described in connection with the attached drawing. Gasket 10 of this invention is shown in FIG. 1. A cross-section of gasket 10 taken along line A-A is shown in FIG. 2. As seen in FIG. 2, gasket 10 is made of knitted wire mesh annular core 11. A jacket 13 is disposed around and completely encloses annular core 11. A retaining ring 14 is disposed around the periphery of gasket 10 and imbedded into jacket 13.

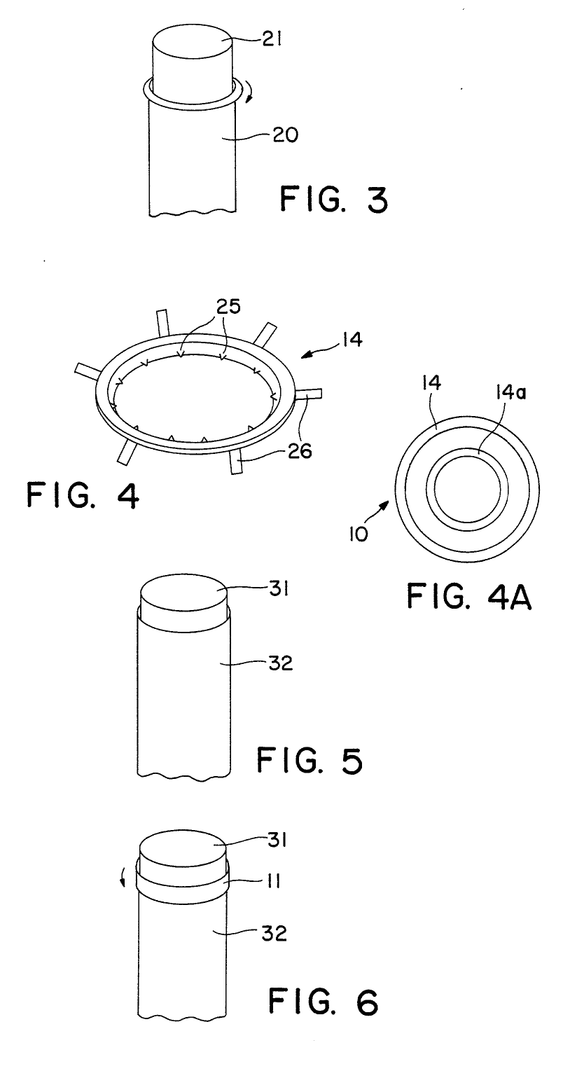

Wire mesh core 11 is preferably made from a stainless steel wire. The stainless steel wire is knitted into the form of a hose or sock. As shown on FIG. 3, the knitted wire mesh in the form of a hose or sock 20 is placed over a cylindrical pipe or tool 21 and then rolled down like a stocking in the direction of the arrow in FIG. 3 to produce a loose-knitted wire ring. The wire ring is then calendered, and then compressed to a substantially round cross-section, as shown for wire mesh annular core 11 in FIG. 2.

Jacket 13 enclosing wire mesh core 11 is preferably made of a plurality of ePTFE layers 12a and a plurality of layers of a barrier material 12b. As shown in FIG. 2, ePTFE layers 12a alternate with layers of a barrier material 12b. The ePTFE is made according to teachings in U.S. Pat. No. 3,953,566. The barrier material is any material that has chemical and thermal resistance and renders jacket 13 (and hence gasket 10) substantially impermeable. As used herein, “substantially impermeable” means having a leak rate of less than 0.01 mg/mis. The leak rate is measured as follows. The gasket is placed between two test flanges 100a and 100b , as shown in FIG. 2A. (Test flanges 100a and 100b are glass-lined flanges, size DN150.) This forms a test chamber 101. A reference chamber 102 is formed by two other test flanges 103a and 103b that are welded together. Reference chamber 102 is thus completely air-tight. Both test chamber 101 and reference chamber 102 are pressurized to 8 bar with nitrogen using the system illustrated in FIG. 2A. A differential pressure transducer 104 is used to measure any pressure drop in test chamber 101 with reference to the constant pressure maintained in reference chamber 102. This pressure drop will occur as nitrogen escapes test chamber 101 through the gasket. The rate of the pressure drop is recorded in units of milligrams per meter per second. This is the leak rate for the gasket.

The barrier material used in the present invention is preferably a fluoropolymer such as densified ePTFE, or FEP, or PFA. Most preferably, it is FEP.

In order to produce the necessary durability for gasket 10, it is necessary that jacket 13 have a cut-through resistance of greater than 1000 Joules (preferably greater than 2000 Joules, and most preferably greater than 3000 Joules) and a flex life of greater than 4 million cycles (preferably greater than 5 million cycles, more preferably greater than 6 million cycles, still more preferably greater than 7 million cycles, and most preferably greater than 8 million cycles).

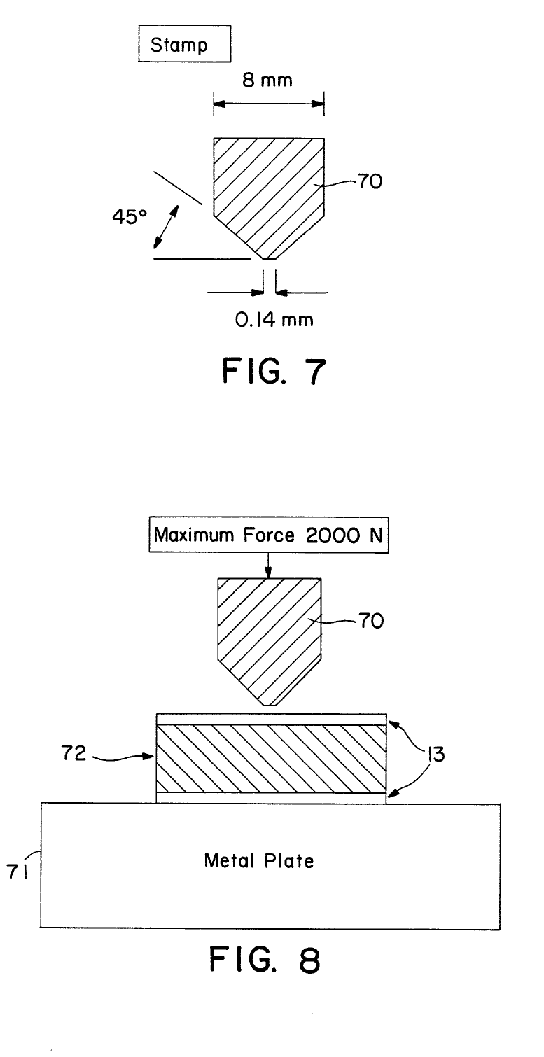

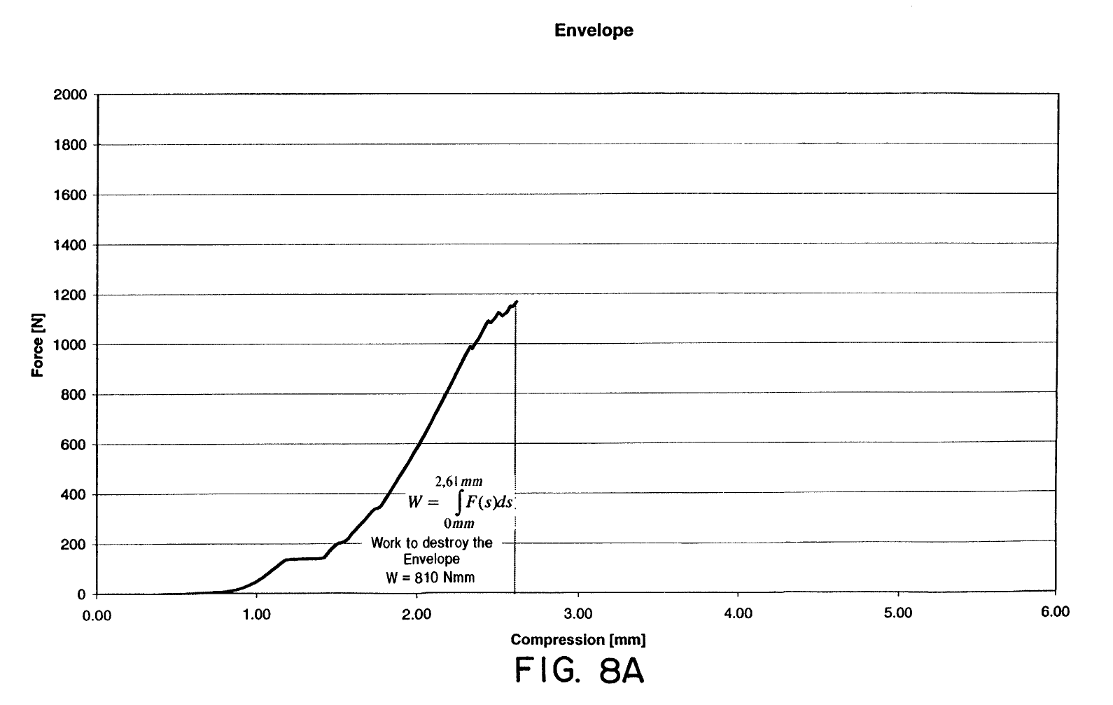

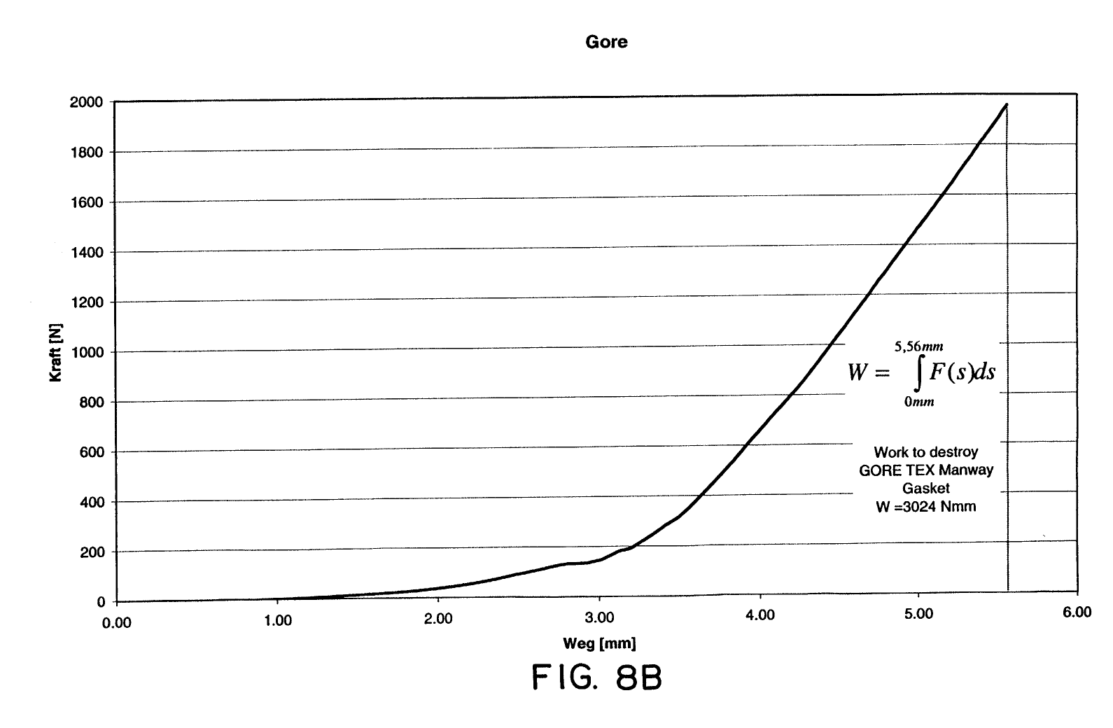

The cut-through resistance test is performed as follows, with reference to FIGS. 7 and 8. A stamp 70 having the dimensions shown in FIG. 7 is affixed to the . upper clamp of an Instron Test Machine (not shown). A metal plate 71 is placed below the stamp. A sample 72 having jacket 13 (or an envelope) on it is placed between stamp 70 and metal plate 71. Stamp 70 is moved into contact with sample 72 so that it just touches sample 72. The Instron machine is then programmed to compress the sample at a rate of 1 mm/min (at ambient temperature). The force applied by the machine and the distance traveled by stamp 70 are recorded until stamp 70 breaks through jacket 13 (or the envelope). In a plot of force vs. distance for the test, such as those shown in FIGS. 8A and 8B, the area under the curve from 0 to the cut through point is the work required to cut through the jacket. The area is calculated using the formula shown in FIGS. 8A and 8B. The work that is calculated is in units of Nmm, or Joules.

The flex life resistance test is performed according to ASTM Standard Test Designation D 2176-97a, “Standard Test Method for Folding Endurance of Paper by the M.I.T. Tester,” using a Tinius Olsen Folding Endurance Tester Model No. 1, with the following selections and modifications to the procedure: a 2.27 kg weight is used instead of a 1 kg weight; the gap width for the jaws is 0.03 in. (the inventive sample had to be pounded down at one edge with a ball peen hammer to fit into the jaws, but the fold region was not touched); a number 8 spring is used; and the samples are die cut to a width of 12.7 mm (instead of 15 mm) and a length of 127 mm (instead of a minimum of 130 mm). Results are reported as the number of double folds, or cycles, that the sample requires before breaking.

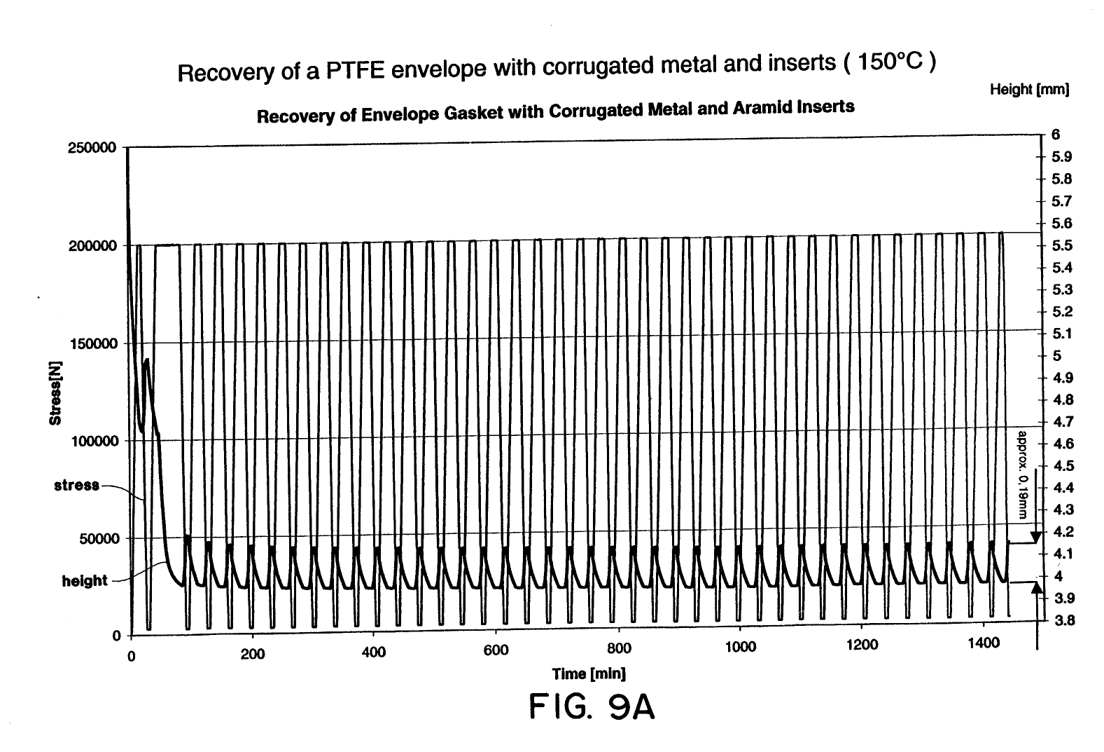

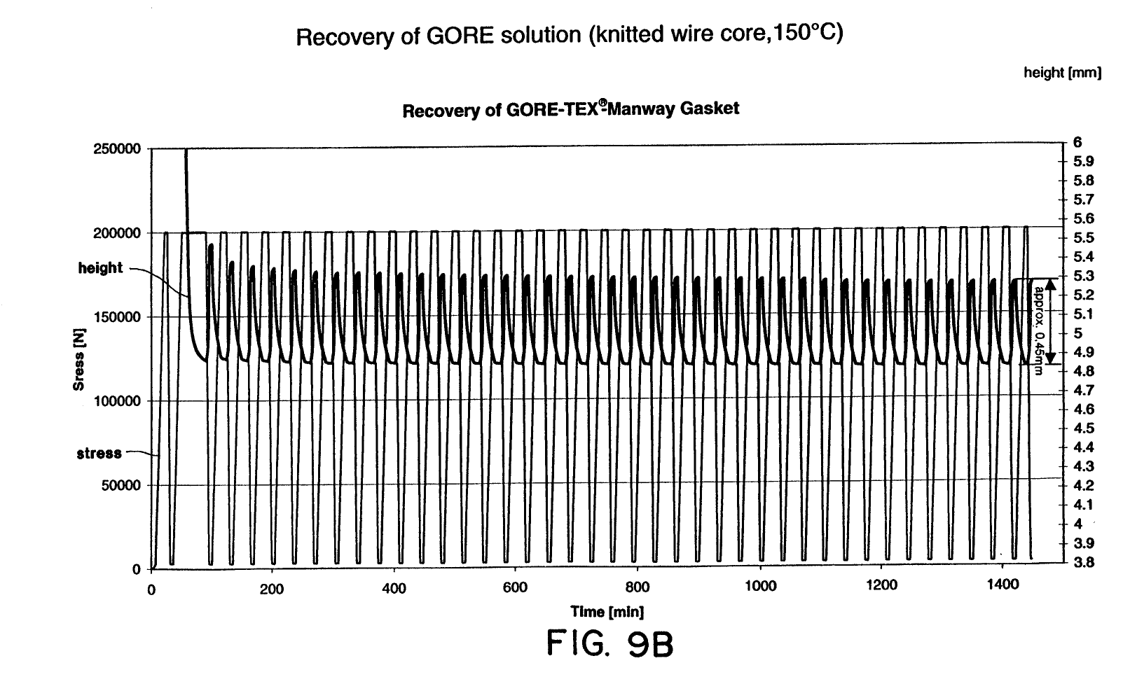

Another important property of the inventive gasket is resilience, or recovery. A typical envelope gasket has a recovery of only about 5%. The inventive gasket, however, has a recovery of about 9%. This means that the inventive gasket can be repeatably compressed and decompressed and still provide a suitable seal over time. With less recovery, conventional gaskets tend to flatten out and fail to provide adequate seals in subsequent uses. The resilience, or recovery, of the gasket is tested as follows. The gasket is placed between two glass-lined flanges, size DN150. The flange pair (with the gasket) is then compressed with a force of 200,000 N. The compressive force is then removed and reapplied (again 200,000 N) while the temperature is increased to 150 degrees C., where it remains for the duration of the test. The compressive force is then cycled off and on for 39 cycles over about 1350 minutes. As shown in FIGS. 9A and 9B, a plot is generated for the compressive force and for the height of the gasket throughout the test. With reference to FIGS. 9A and 9B, the recovery of a gasket is reported as a percentage at the end of the test and is (the difference between the height of the gasket after release of the last compressive stress and the height of the gasket at the peak of the last compressive stress) divided by (the height of the gasket at the peak of the last compressive stress).

Retaining ring 14 serves to prevent gasket 10 from expanding radially outwardly during axial compression. Retaining ring 14 is preferably made of stainless steel. It is formed by methods such as laser cutting out of a stainless steel plate. As shown in FIG. 4, retaining ring 14 preferably has teeth 25 protruding from its inner surface. Teeth 25 help retaining ring 14 engage and be securely seated within and attached to jacket 13. Retaining ring 14 also preferably has tabs 26 which are bent up or down to engage the surface of the manway or the vessel after installation to help align and seat gasket 10 with retaining ring 14 in place. Also preferably, jacket 13 has a groove calendered along its outer diameter and into which retaining ring 14 is inserted.

For added mechanical stability of the inventive gasket, a second retaining ring 14a is disposed at the inner circumference of gasket 10 as shown in FIG. 4a. Just as first retaining ring 14 prevents gasket 10 from deforming radially outwardly during compression, second retaining ring 14a assures that gasket 10 does not expand radially inwardly. Second retaining ring 14a is also made of stainless steel, but preferably does not include teeth or tabs.

To produce gasket 10, the barrier material layers 12b and ePTFE layers 12a are placed together in alternating layers to form a composite sheet 32 (see FIG. 5). Each of barrier material layer 12b and ePTFE layer 12a may itself consist of multiple plies of the respective material. Composite sheet 32 is wrapped around a cylindrical pipe or tool 31. Wire mesh annular core 11 is then placed over composite sheet 32 near the top of tool 31. Composite sheet 32 is then rolled down over core 11 in the direction of the arrow in FIG. 6 to form the annular shape for gasket 10 in the form of a preformed ring. This preformed ring is then sintered in a hot air oven. A groove is then calendered in the middle of the outer circumference of the ring such that retaining ring 14 can be fixed exactly around jacket 13. Jacket 13 is then compressed around the portion of retaining ring 14 in the groove of jacket 13. Second retaining ring 14a is disposed at the inner circumference of jacket 13 as needed.

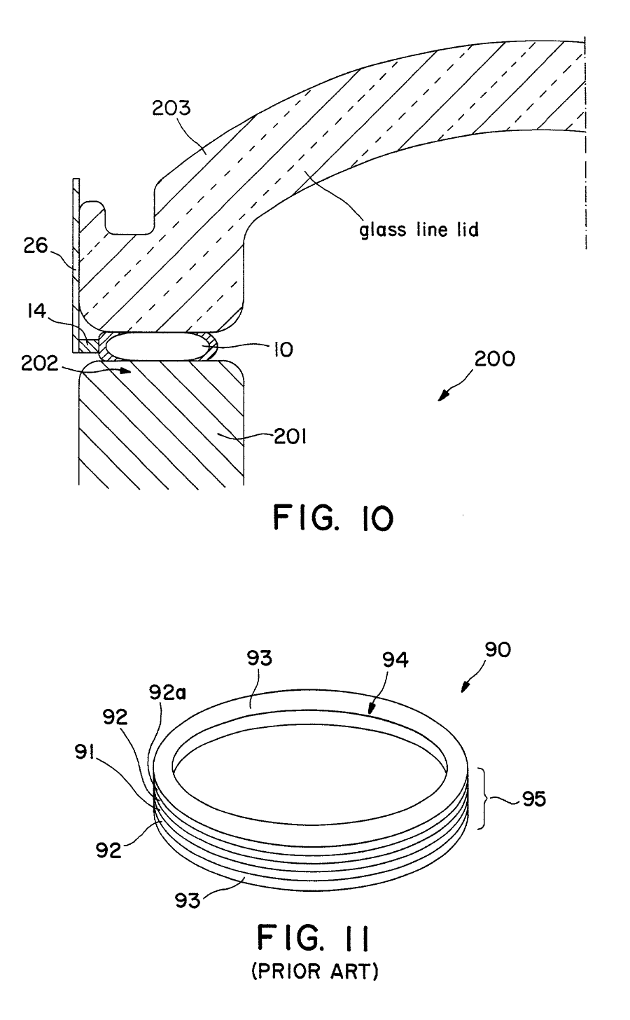

In use, gasket 10 is disposed around the periphery 202 of a manway opening 200 as shown in FIG. 10. Vessel 201 has a glass-lined steel lid 203 covering it. Lid 203 compresses gasket 10 to form a seal. When lid 203 is opened, gasket 10 resiliently expands and is prepared for another compression cycle when lid 203 is closed again. Gasket 10 thus is a reusable gasket that allows frequently opened manways to be reliably and repeatably sealed.

The following examples are provided to illustrate the invention, but are not intended to limit it.

### EXAMPLES

### Example 1

A gasket was produced according to the teachings of this invention. The gasket had an annular wire mesh core and an FEP and ePTFE composite jacket. The gasket was tested for cut-through resistance and resiliency using the tests described above. The results are reported graphically in FIGS. 8B and 9B, respectively.

With reference to the cut-through resistance results in FIG. 8B, the inventive gasket did not break even after the maximum load of 2000 N was applied. The work was calculated at that point, however, because that was the end of the test. The exact formula used to calculate the work performed on the inventive gasket at that point was the integral from 0 to 3.2 mm of (50.68s³−120.36s²+119.74s−8.65ds)+the integral from 3.2 to 4.85 of (853.40s−1955.9ds). This value was about 3024 Joules. Because the jacket was not yet cut through, the cut-through resistance of this inventive gasket is greater than 3024 Joules.

With reference to the resilience test results in FIG. 9B, the inventive gasket showed about 9% resilience (or recovery) at the end of the test. With reference to the graph in FIG. 9B, this value was calculated as 0.45 mm divided by 4.84 mm.

The gasket of this Example 1 was also tested for leak rate using the test described above. The gasket showed a leak rate of 0.0039 mg/m/s.

### Comparative Example A

An envelope gasket was obtained from a distributor called Kudernak, in Frankfurt, Germany. It was a PTFE envelope gasket UR DIN 28148-BWR with 2 aramid inserts 2C 4400 DN 150-21,5 asbestos free. This gasket was tested for cut-through resistance and resiliency using the tests described above. The results are reported graphically in FIGS. 8A and 9A, respectively.

With reference to the cut-through resistance results in FIG. 8A, the envelope gasket broke at a load of about 1180N. The work was calculated at that point. The exact formula used to calculate the work performed on the envelope gasket at that point was the integral from 0 to 2.61 mm of (65.98s³+44.42s²−70.65s+8.72ds). This value was about 810 Joules.

With reference to the resilience test results in FIG. 9A, the envelope gasket showed about 5% resilience (or recovery) at the end of the test. With reference to the graph in FIG. 9A, this value was calculated as 0.19 mm divided by 3.98 mm.

### Example 2

A sample of the jacket for the gasket of Example 1 was obtained. This sample was tested for flex life according to the test described in the specification above. The sample flexed for over 8 million cycles without breaking.

### Comparative Example B

The envelope was removed from the envelope gasket used in Comparative Example A. The envelope was tested for flex life according to the test described in the specification above. The sample broke after only 3.8 million cycles.

What is claimed is:

1. A gasket comprising:
(a) a knitted wire mesh annular core;
(b) a jacket disposed around and enclosing said core, said jacket comprising expanded polytetrafluoroethylene;
(c) wherein said jacket has a flex life of greater than 4,000,000 cycles;
and
(d) wherein said jacket has a cut-through resistance of greater than 1000 Joules.

2. A gasket as defined in claim 1 wherein said gasket has a recovery of greater than 5%.

3. A gasket as defined in claim 2 wherein said gasket has a recovery of greater than 6%.

4. A gasket as defined in claim 2 wherein said gasket has a recovery of greater than 7%.

5. A gasket as defined in claim 2 wherein said gasket has a recovery of greater than 8%.

6. A gasket as defined in claim 2 wherein said gasket has a recovery of about 9%.

7. A gasket as defined in claim 1 wherein said jacket has a flex life of greater than 5,000,000 cycles.

8. A gasket as defined in claim 1 wherein said jacket has a flex life of greater than 6,000,000 cycles.

9. A gasket as defined in claim 1 wherein said jacket has a flex life of greater than 7,000,000 cycles.

10. A gasket as defined in claim 1 wherein said jacket has a flex life of greater than 8,000,000 cycles.

11. A gasket as defined in claim 1 wherein said jacket has a cut-through resistance of greater than 2,000 Joules.

12. A gasket as defined in claim 1 wherein said jacket has a cut-through resistance of greater than 3,000 Joules.

13. A gasket as defined in claim 1 wherein said jacket comprises at least one layer of expanded polytetrafluoroethylene and at least one substantially impermeable barrier layer.

14. A gasket as defined in claim 13 wherein said barrier layer is FEP.

15. A gasket as defined in claim 1 wherein said knitted wire mesh annular core is stainless steel.

16. A gasket as defined in claim 1 wherein said jacket has an outer circumference and said gasket further comprises a retaining ring disposed around and contacting said outer circumference of said jacket.

17. A gasket as defined in claim 16 further comprising a plurality of pins disposed on said retaining ring, said pins engaging said outer circumference of said jacket.

18. A gasket as defined in claim 16 wherein said retaining ring has an outer circumference and further comprises a plurality of tabs extending from said outer circumference of said retaining ring.

19. A gasket as defined in claim 1 wherein said jacket has an outer circumference and an inner circumference, and said gasket further comprises a first retaining ring disposed around and contacting said outer circumference of said jacket and a second retaining ring disposed inside and contacting said inner circumference of said jacket.

20. A gasket as defined in claim 1 wherein said core has an outer circumference and an inner circumference, and said gasket further comprises a first retaining ring disposed between said outer circumference of said core and said jacket and a second retaining ring disposed between said inner circumference of said core and said jacket, said jacket thus enclosing all of said core and said first and second retaining rings.

21. A gasket as defined in claim 1 wherein said gasket has a leak rate of less than 0.01 mg/m/s.

22. A gasket as defined in claim 1 wherein said leak rate is 0.0039 mg/mis.

23. A gasket comprising:
(a) a knitted stainless steel wire mesh annular core;
(b) a jacket having an outer circumference and being disposed around and enclosing said core, said jacket comprising a plurality of layers of expanded polytetrafluoroethylene and a plurality of layers of FEP;
(b) a retaining ring disposed around and contacting said outer circumference of said jacket;
(c) a plurality of pins disposed on said retaining ring, said pins engaging said outer circumference of said jacket;
(d) wherein said ePTFE jacket has a flex life of greater than 8,000,000 cycles; and
(e) wherein said ePTFE jacket has a cut-through resistance of about 3000 Joules.

24. A method of sealing a manway having a base with an opening in it and a glass-lined steel lid for covering the opening, the lid having an open position and a closed position, said method comprising the steps of:
(1) providing a gasket comprising:
(a) a knitted wire mesh annular core;
(b) a jacket disposed around and enclosing said core, said jacket comprising expanded polytetrafluoroethylene;
(c) wherein said jacket has a flex life of greater than 4,000,000 cycles; and
(d) wherein said jacket has a cut-through resistance of greater than 1000 Joules; and
(2) disposing said gasket between said lid in said closed position and said base.
